(19) United States
(12) Patent Application Publication
(10) Pub. No.: US 2011/0093092 A1
(43) Pub. Date: Apr. 21, 2011

(54) METHOD AND APPARATUS FOR CREATING AND REPRODUCING OF MOTION EFFECT

(76) Inventors: Bum Suk CHOI, Yuseong-gu (KR); Eun Seo LEE, Seo-gu (KR); Kyung Ro YOON, Seoul (KR)

(21) Appl. No.: 12/907,694

(22) Filed: Oct. 19, 2010

Related U.S. Application Data
(60) Provisional application No. 61/252,777, filed on Oct. 19, 2009.

(30) Foreign Application Priority Data
Aug. 20, 2010 (KR) 10-2010-0080894

(51) Int. Cl. G05B 15/00

(52) U.S. Cl. 700/11

(57) ABSTRACT

Provided is an apparatus for generating and reproducing a motion effect, including: a receiving module to receive a signal with respect to a motion apparatus providing a motion to a user; a generating module to generate a control signal with respect to the motion apparatus according to the signal with respect to the motion apparatus, based on tables where schemas indicating a conceptual motion effect with respect to the motion apparatus are stored; and a transmitting module to transmit the control signal to the motion apparatus.

### CROSS-REFERENCE TO RELATED APPLICATIONS

This application claims the benefit under 35 U.S.C. §119(e) of a U.S. Provisional Application No. 61/252,777, filed on Oct. 19, 2009, in the U.S. Patent and Trade Mark Office, and the benefit under 35 U.S.C. §119(a) of a Korean Patent Application No. 10-2010-0080894, filed on Aug. 20, 2010, in the Korean Intellectual Property Office, the entire disclosures of which are incorporated herein by reference for all purposes.

### BACKGROUND

1. Field of the Invention

Embodiments of the present invention relate to an apparatus and method for generating and reproducing a motion effect.

2. Description of the Related Art

One of important sensory effects to be considered may be an effect associated with a motion. A motion effect enables a user to experience more realistic feeling about motions an actor or an actress feels in a movie. The motion effect corresponds to a popular sensory effect that people can experience in a movie theater, a game room, a theme park, and the like.

The motion effect may be obtained using a motion chair. The motion chair generally includes a motor and an axis placed underneath or above a chair. A motion level of the chair may be determined based on a number of motors and the length of axis.

Motion chairs currently released in the market show different mechanical characteristics depending on manufacturers of the motion chairs. In the motion effect of a corresponding motion chair, the scope of expressions may vary depending on manufacturers.

Accordingly, metadata to express the motion effect with respect to the motion chair may also vary depending on manufacturers. Thus, there is a need for metadata that may express a motion effect commonly adaptable with respect to all the motion chairs.

### SUMMARY

An aspect of the present invention provides an apparatus and method of generating and reproducing a motion effect that is independent with respect to a mechanical characteristic of a motion chair and is commonly adaptable with respect to all the motion chairs.

An aspect of the present invention also provides an apparatus and method of generating and reproducing a conceptual motion effect that may provide a variety of motion effects with respect to a motion chair.

According to an aspect of the present invention, there is provided an apparatus for generating and reproducing a motion effect, including: a receiving module to receive a signal with respect to a motion apparatus providing a motion to a user; a generating module to generate a control signal with respect to the motion apparatus according to the signal with respect to the motion apparatus, based on tables where schemas indicating a conceptual motion effect with respect to the motion apparatus are stored; and a transmitting module to transmit the control signal to the motion apparatus.

According to another aspect of the present invention, there is provided a method of generating and reproducing a motion effect, including: receiving a signal with respect to a motion apparatus providing a motion to a user; generating a control signal with respect to the motion apparatus according to the signal with respect to the motion apparatus, based on tables where schemas indicating a conceptual motion effect with respect to the motion apparatus are stored; and transmitting the control signal to the motion apparatus.

### EFFECT

According to embodiments of the present invention, there may be provided an apparatus and method of generating and reproducing a motion effect in which an expression of metadata to express a motion effect by a mechanical characteristic of a motion chair may not be limited by depicting a conceptual motion on a screen.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates motion chairs according to an embodiment of the present invention;

FIG. 2 illustrates a configuration of an apparatus for generating and reproducing a motion effect according to an embodiment of the present invention;

FIG. 3 illustrates 6 degrees of freedom (DoF) with respect to a motion apparatus according to an embodiment of the present invention;

FIG. 4 illustrates a method of generating and reproducing a motion effect according to an embodiment of the present invention;

FIGS. 5A and 5B illustrate basic motion patterns stored in a basic motion table according to an embodiment of the present invention;

FIGS. 6A through 6E illustrate combinational motion patterns stored in a combinational motion table according to an embodiment of the present invention;

FIGS. 7A through 7I illustrate pattern types with respect to combined patterns according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

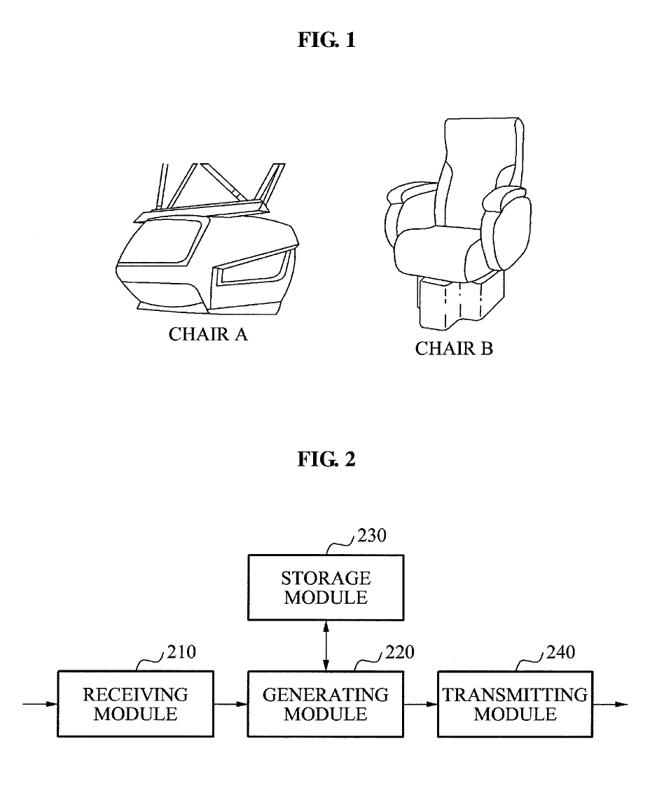

FIG. 1 illustrates motion chairs A and B according to an embodiment of the present invention. When designing motion data to express a motion effect, a manufacturer may generate metadata of a sensory effect based on audio visual data. Here, the manufacturer may be unaware of a mechanical characteristic of a motion chair in which the motion effect may be reproduced, and may be unaware about which motion chair will reproduce the metadata for the motion effect.

Accordingly, from viewpoint of the manufacturer, it may be more appropriate to depict a motion effect by a conceptual motion on a screen. Hereinafter, why the motion effect needs to be conceptual will be described with reference to FIG. 1.

For example, it may be assumed that two types of motion chairs, for example, the motion chair A and the motion chair B are present, the motion chair A may express a roll, a yaw, and a surge, and the motion chair B may express only the roll.

When each of the motion chair A and the motion chair receives an instruction of a physical motion for expressing a motion effect “yawing by 90 degrees”, whether each of the motion chair A and the motion chair B can express the instructed physical potion may depend on a function of each of the motion chair A and the motion chair B. In FIG. 1, the motion chair A has a yawing function and thus, may express the motion effect “yawing by 90 degrees”.

However, the motion chair B does not have the yawing function and thus, may not express the motion effect “yawing by 90 degrees”.

When each of the motion chair A and the motion chair B receives an instruction of a conceptual motion for expressing a motion effect “turn left”, the motion chair A may more realistically reproduce the motion effect by using the rolling effect and the yawing effect.

However, the motion chair B may express the conceptual motion “turn left” using only the rolling function. Even though a reality expressed by the motion chair B may be deteriorated compared to the motion chair A, the motion chair B may express the conceptual motion “turn left”, which is different from the case where the motion chair B receives the instruction of the physical motion.

As described above, in order to apply, to a corresponding engine, the motion of the motion chair for expressing a variety of motion effects, to transfer a conceptual intent about a meaning or the motion of the motion effect may be appropriate rather than to instruct the physical motion.

By applying metadata expressing the motion effect through the conceptual motion, a motion chair may express a motion most suitable for the corresponding motion chair.

FIG. 2 illustrates a configuration of an apparatus for generating and reproducing a motion effect according to an embodiment of the present invention. Referring to FIG. 2, the apparatus for generating and reproducing the motion effect may include a receiving module 210, a generating module 220, a storage module 230, and a transmitting module 240.

The receiving module 210 may receive a signal with respect to a motion apparatus providing a motion to a user.

The generating module 220 may generate a control signal with respect to the motion apparatus according to the signal with respect to the motion apparatus, based on tables where schemas indicating a conceptual motion effect with respect to the motion apparatus are stored.

The generating module 220 may generate the control signal with respect to the motion apparatus by combining at least two motion patterns defined in a basic motion table and a combinational motion table, so that the at least two motion patterns may have a single duration time and a single start point.

For example, the generating module 220 may express a complex motion such as a motion of a boat sailing into one direction on the sea by overlappingly using the at least two motion patterns, for example, a move pattern and a wave pattern to have the single duration time, the single start point, and the like.

The storage module 230 may store the tables where the schemas indicating the conceptual motion effect are stored.

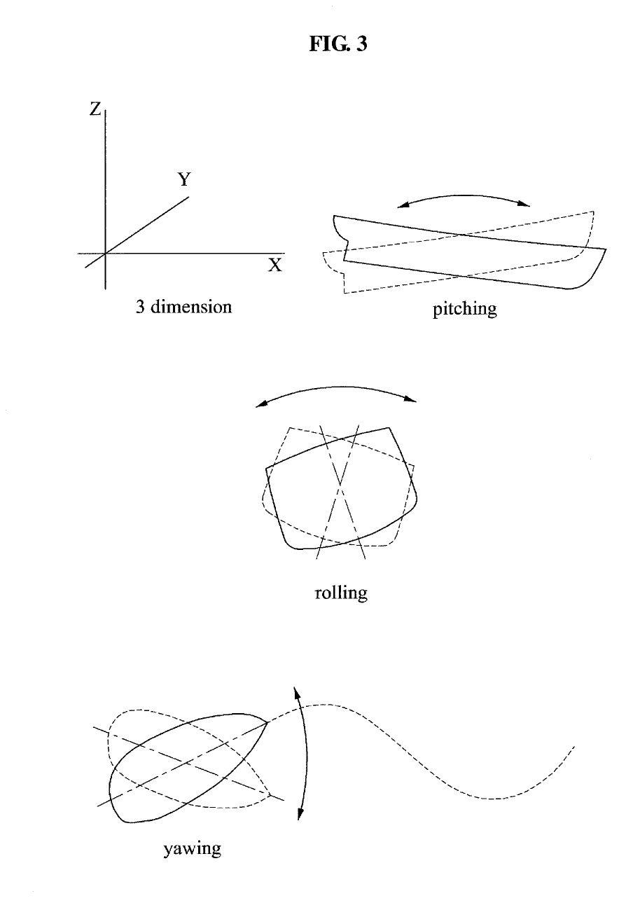

The tables where the schemas indicating the conceptual motion effect are stored may include a basic motion table defining a basic motion pattern based on 6DoF with respect to the motion apparatus and a combinational motion table defining a combinational motion pattern with respect to the motion apparatus. The 6DoF will be described with reference to FIG. 3.

Hereinafter, the tables where the schemas indicating the motion effect with respect to the motion apparatus, defined in the embodiment of the present invention, will be further described.

TABLE 1
Basic motion patterns

| Pattern Name | Semantics |
|---|---|
| Move | This pattern indicates a three-dimensional (3D) motion |
| | of 6DoF, and indicates a change in a location to three |
| | axes without a rotation. |
| Incline | This pattern indicates a pitch, a yaw, and a roll of 6DoF, |
| | and indicates a rotation without changing a location. |

Table 1 shows the basic motion table. The basic motion table may include a move pattern indicating a rotation-free 3D motion based on the 6DoF with respect to the motion apparatus, and an incline pattern indicating a rotation including a pitch, a yaw, and a roll based on the 6DoF.

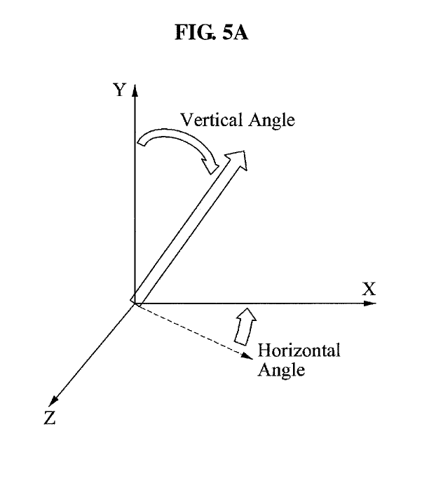

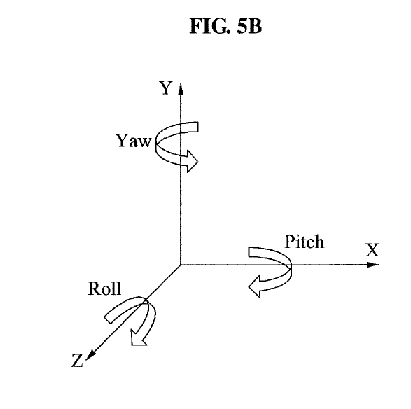

The meaning with respect to the move pattern and the incline pattern of the basic motion table will be described with reference to FIG. 5.

TABLE 2
Combinational motion patterns

| Pattern Name | Semantics |
|---|---|
| Shake | This pattern indicates a repetitive motion into one direction and into an |
| | opposite direction of the one direction, and is replaceable by |
| | successively employing a move pattern. |
| Wave | This pattern indicates a successive up and down motion such as the |
| | surface of water, and may be expressed by successively expressing a |
| | roll or a pitch of an incline pattern. |
| Spin | This pattern indicates a continuous turning based on a single inner |
| | central point, and may be expressed by continuously expressing a |
| | yaw of an incline pattern. |
| Turn | This pattern indicates a motion in one direction, and may be |
| | expressed by employing a move pattern and an incline pattern. |
| Collide | This pattern indicates a motion occurring due to a collision with |
| | another object, and may be expressed by employing a move pattern |
| | and an incline pattern. |

Table 2 shows the combinational motion table indicating a combinational motion pattern and a meaning thereof. The combinational motion table may include at least one of a shake pattern indicating a repetitive motion into one direction with respect to the motion apparatus and into a direction opposite thereto, a wave pattern indicating a successive up and down motion, a spin pattern indicating a continuous turning based on a single central point, a turn pattern indicating a motion in one direction, and a collide pattern indicating a motion occurring due to a collision between the motion apparatus and another object.

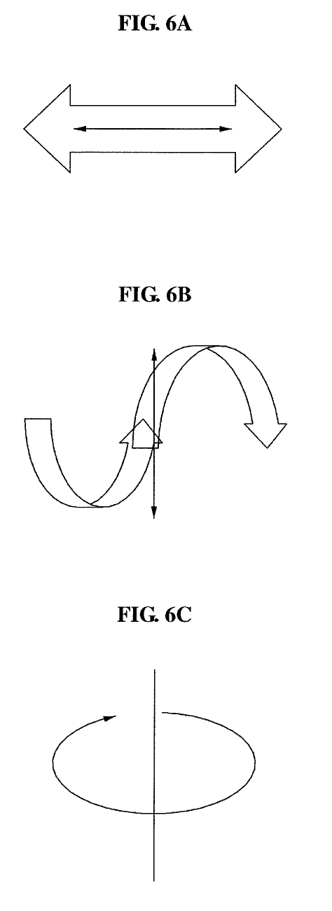

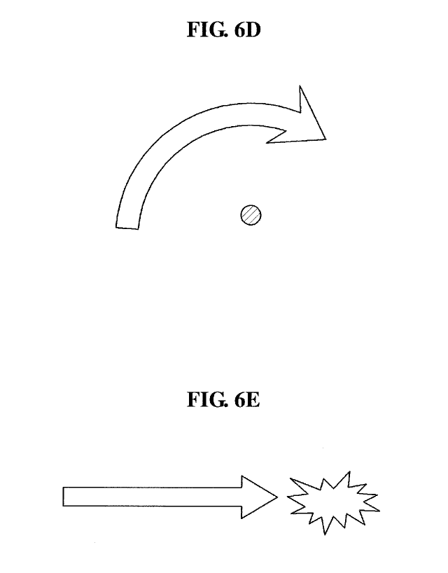

The meaning with respect to the move pattern and the incline pattern of the combinational motion table will be described with reference to FIG. 6.

Hereinafter, syntax and semantics of the motion effect follows as:

```
Syntax
      <!-- ################################################  -->
      <!--  Definition of MotionChair type  -->
      <!-- ################################################  -->
      <complexType name=“MotionType”>
      <complexContent>
      <extension base=“sedl:EffectBaseType”>
      <sequence>
      <element name=“MoveToward” type=“sev:MoveTowardType” minOccurs=“0”/>
      <element name=“Incline” type=“sev:InclineType” minOccurs=“0”/>
      <element name=“Shake” type=“sev:ShakeType” minOccurs=“0”/>
      <element name=“Wave” type=“sev:WaveType” minOccurs=“0”/>
      <element name=“Spin” type=“sev:SpinType” minOccurs=“0”/>
      <element name=“Turn” type=“sev:TurnType” minOccurs=“0”/>
      <element name=“Collide” type=“sev:CollideType” minOccurs=“0”/>
      </sequence>
      </extension>
      </complexContent>
      </complexType>
      <complexType name=“MoveTowardType”>
      <attribute name=“speed” type=“float” use=“optional”/>
      <attribute name=“acceleration” type=“float” use=“optional”/>
      <attribute name=“directionX” type=“float” use=“optional”/>
      <attribute name=“directionY” type=“float” use=“optional”/>
      <attribute name=“directionZ” type=“float” use=“optional”/>
      </complexType>
      <complexType name=“InclineType”>
      <attribute name=“pitchSpeed” type=“float” use=“optional”/>
      <attribute name=“pitchAcceleration” type=“float” use=“optional”/>
      <attribute name=“rollSpeed” type=“float” use=“optional”/>
      <attribute name=“rollAcceleration” type=“float” use=“optional”/>
      <attribute name=“yawSpeed” type=“float” use=“optional”/>
      <attribute name=“yawAcceleration” type=“float” use=“optional”/>
      <attribute name=“pitch” type=“sev:InclineAngleType” use=“optional”/>
      <attribute name=“roll” type=“sev:InclineAngleType” use=“optional”/>
      <attribute name=“yaw” type=“sev:InclineAngleType” use=“optional”/>
      </complexType>
      <complexType name=“ShakeType”>
      <attribute name=“direction” type=“mpeg7:termReferenceType” use=“optional”/>
      <attribute name=“count” type=“float” use=“optional”/>
      <attribute name=“distance” type=“float” use=“optional”/>
      <attribute name=“interval” type=“positiveInteger” use=“optional”/>
      </complexType>
      <complexType name=“WaveType”>
      <attribute name=“direction” type=“mpeg7:termReferenceType” use=“optional”/>
      <attribute  name=“startDirection”  type=“mpeg7:termReferenceType”
use=“optional”/>
      <attribute name=“count” type=“float” use=“optional”/>
      <attribute name=“distance” type=“float” use=“optional”/>
      <attribute name=“interval” type=“positiveInteger” use=“optional”/>
      </complexType>
      <complexType name=“SpinType”>
      <attribute name=“direction” type=“mpeg7:termReferenceType” use=“optional”/>
      <attribute name=“count” type=“float” use=“optional”/>
      <attribute name=“interval” type=“positiveInteger” use=“optional”/>
      </complexType>
      <complexType name=“TurnType”>
      <attribute name=“direction” type=“mpeg7:termReferenceType” use=“optional”/>
      <attribute name=“speed” type=“float” use=“optional”/>
      </complexType>
      <complexType name=“CollideType”>
      <attribute name=“directionX” type=“sev:angleType” use=“optional”/>
      <attribute name=“directionY” type=“sev:angleType” use=“optional”/>
      <attribute name=“directionZ” type=“sev:angleType” use=“optional”/>
      <attribute name=“speed” type=“float” use=“optional”/>
      </complexType>
      <simpleType name=“angleType”>
      <restriction base=“integer”>
      <minInclusive value=“0”/>
      <maxInclusive value=“359”/>
      </restriction>
      </simpleType>
      <simpleType name=“WaveDirectionType”>
      <restriction base=“string”>
      <enumeration value=“left-right”/>
      <enumeration value=“front-rear”/>
      </restriction>
      </simpleType>
      <simpleType name=“TurnAngleType”>
      <restriction base=“integer”>
      <minInclusive value=“−180”/>
      <maxInclusive value=“180”/>
      </restriction>
      </simpleType>
      <simpleType name=“ShakeDirectionType”>
      <restriction base=“string”>
      <enumeration value=“heave”/>
      <enumeration value=“sway”/>
      <enumeration value=“surge”/>
      </restriction>
      </simpleType>
      <simpleType name=“StartDirectionType”>
      <restriction base=“string”>
      <enumeration value=“up”/>
      <enumeration value=“down”/>
      </restriction>
      </simpleType>
      <simpleType name=“SpinDirectionType”>
      <restriction base=“string”>
      <enumeration value=“xf”/>
      <enumeration value=“xb”/>
      <enumeration value=“yf”/>
      <enumeration value=“yb”/>
      <enumeration value=“zf”/>
      <enumeration value=“zb”/>
      </restriction>
      </simpleType>
      <simpleType name=“InclineAngleType”>
      <restriction base=“integer”>
      <minInclusive value=“−360”/>
      <maxInclusive value=“360”/>
      </restriction>
      </simpleType>
```

TABLE 3
Semantics of the MotionChairType:

| Name | Definition |
|---|---|
| move | Describes a simple motion into one direction. |
| | The type is sev: MoveType. |
| Incline | Describes a pitch, a yaw, and a roll. |
| | The type is sev: InclineType. |
| Shake | Describes a repetitive motion into one direction and an opposite |
| | direction of the one direction. |
| | The type is sev: ShakeType. |
| Wave | Describes a repetitive motion from side-up to side down, or from |
| | forward-up to backward-dwon such as the surface of water. |
| | The type is sev: WaveType. |
| Spin | Describes a continuous turning based on a single central point |
| | without changing a location. The type is sev: SpinType. |
| Turn | Describes a motion that curves or bends to change a direction. |
| | The type is sev: TurnType. |
| Collide | Describes a motion colliding against one object. |
| | The type is sev: CollideType. |

TABLE 4
Semantics of the MoveType:

| Name | Definition |
|---|---|
| X | a distance to an X axis based on a centimeter unit. |
| Y | a distance to an Y axis based on a centimeter unit. |
| Z | a distance to a Z axis based on a centimeter unit. |
| speed | a speed based on a unit of cm/s. |
| acceleration | an acceleration based on a unit of cm/s². |

With respect to the motion apparatus, the move pattern may include at least one move pattern type among a movement distance in an X axis, a movement distance in an Y axis, a movement distance in a Z axis, a movement speed, and a movement acceleration.

TABLE 5
Semantics of the InclineType:

| Name | Definition |
|---|---|
| xRotation | Describes a rotation of a degree unit to an X axis. |
| | The type is sev: InclineAngleType. |
| yRotation | Describes a rotation of a degree unit to an Y axis. |
| | The type is sev: InclineAngleType. |
| zRotation | Describes a rotation of a degree unit to a Z axis. |
| | The type is sev: InclineAngleType. |
| speed | Describes a speed based on a unit of ∘/s. |
| acceleration | Describes an acceleration based on a unit of ∘/s². |

With respect to the motion apparatus, the incline pattern may include at least one incline pattern type among an incline rotation in an X axis, an incline rotation in an Y axis, an incline rotation in a Z axis, a rotation speed and a rotation acceleration.

TABLE 6
Semantics of the ShakeType:

| Name | Definition |
|---|---|
| direction | Describes a direction of a shake motion. |
| | The type is sev: ShakeDirectionType. |
| count | Describes a counted number of times shake motions during a |
| | duration time. |
| distance | Describes a distance between two ends of the shake motion |
| | based on a centimeter unit. |
| interval | Describes a break time in an interval of a shake motion. |
| | The type is si:absTimeScheme and si:timeScale. |

The shake pattern may be optionally employed. With respect to the motion apparatus, the shake pattern may include at least one shake pattern type among a direction of a shake motion, a counted number of shake motions during a duration time of the motion effect, a distance of the shake motion, and an interval of the shake motion.

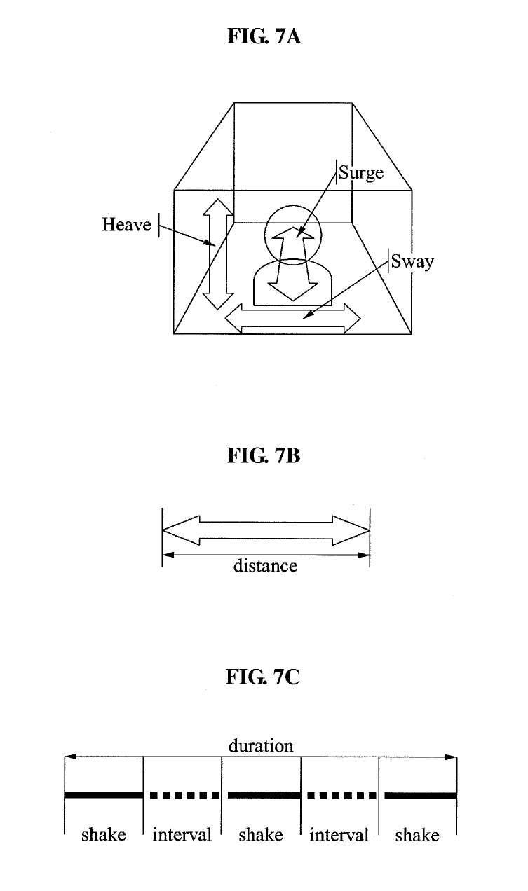

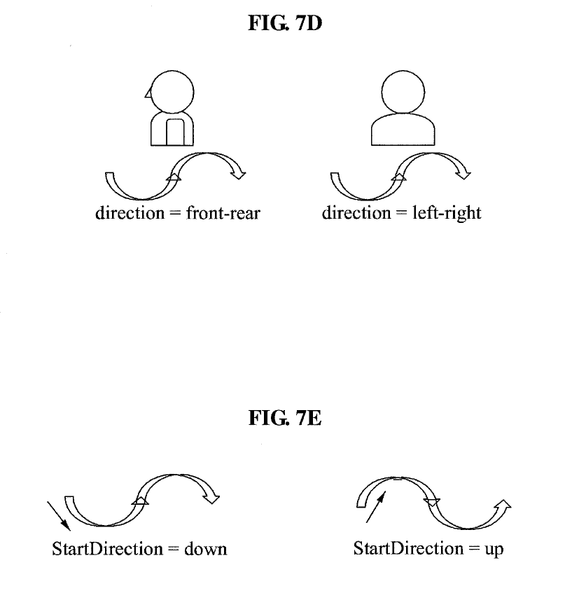

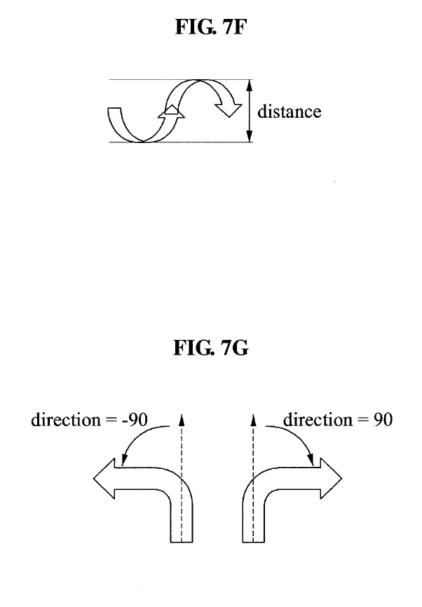

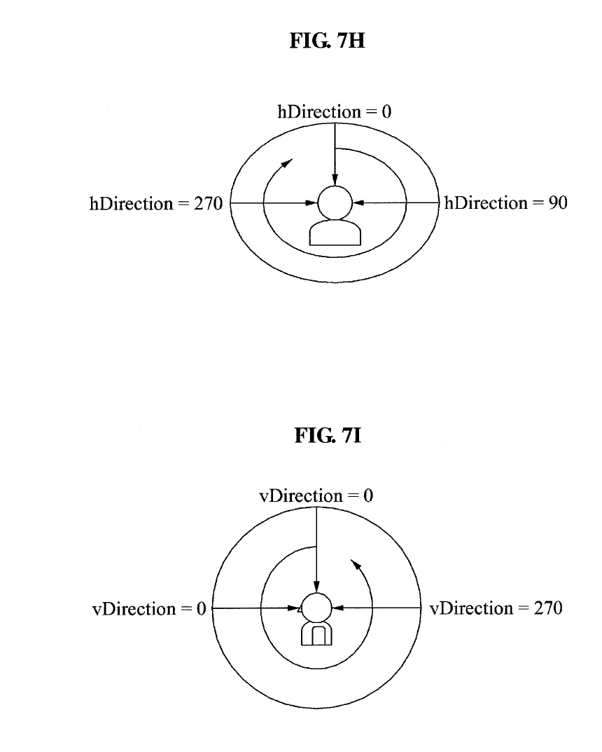

Each meaning of wave pattern types will be described with reference to FIG. 7.

TABLE 7
Semantics of the WaveType:

| Name | Definition |
|---|---|
| direction | Describes a direction of a wave motion. |
| | The type is sev: WaveDirectionType. |
| startDirection | Describes whether a wave motion starts towards an up |
| | direction or a down direction. |
| | The type is sev: startDirectionType. |
| count | Describes a counted number of wave motions during a |
| | duration time. |
| distance | Describes, based on a centimeter unit, a distance between |
| | a top location and a bottom location moved through a |
| | wave motion. |
| interval | Describes a break time in an interval of the wave motion. |
| | The type is si:absTimeScheme and si:timescale. |

The wave pattern may be optionally used. With respect to the motion apparatus, the wave pattern may include at least one wave pattern type among a direction of a wave motion, a start direction of the wave motion, a counted number of wave motions during a duration time of the motion effect, a distance between a top location and a bottom location moved through the wave motion, and an interval of the wave motion.

Each meaning of wave pattern types will be described with reference to FIG. 7.

TABLE 8
Semantics of the SpinType:

| Name | Definition |
|---|---|
| direction | Describes a spine direction to each of three axes. |
| | The type is sev: SpinDirectionType. |
| count | Describes a counted number of spins during a duration time. |
| interval | Describes a break time in an interval of a spin motion. |
| | The type is si:absTimeScheme and si:timeScale. |

A spin pattern may be optionally used, and may include at least one spin pattern type among a spin direction to each of three axes, a counted number of spins during a duration time of the motion effect, and a spin interval.

TABLE 9
Semantics of the TurnType:

| Name | Definition |
|---|---|
| direction | Describes a turn angle based on a degree unit. |
| | The type is sev: TurnAngleType. |
| speed | Describes a turning speed based on a unit of ∘/s. |

The turn pattern may include at least one turn pattern type of a turn angle and a turning speed. Each meaning of turn pattern types will be described with reference to FIG. 7.

TABLE 10
Semantics of the CollideType:

| Name | Definition |
|---|---|
| hDirection | Describes a horizontal direction receiving an impact. |
| | The type is sev: AngleType. |
| vDirection | Describes a vertical direction receiving an impact. |
| | The type is sev: AngleType. |
| speed | Describes a speed of a colliding object based on a unit of |
| | cm/s. |

The collide pattern may include at least one collide pattern type among one horizontality-based direction (hDirection) receiving an impact due to the collision and one verticality-based direction (vDirection).

Each meaning of collide pattern types will be described with reference to FIG. 7.

The transmitting module 240 may transmit a control signal to the motion apparatus.

FIG. 3 illustrates 6DoF with respect to a motion apparatus according to an embodiment of the present invention.

Referring to FIG. 3, the 6DoF indicates all the operational elements used for robotics or a virtual reality system, and may include three axes X (horizontality), Y (verticality), and Z (depth), a pitch, a yaw, and a roll.

The pitch indicates a movement to up and down, the yaw indicates one rotation based on an up-and-down axis, and the roll indicates a movement to the left and the right.

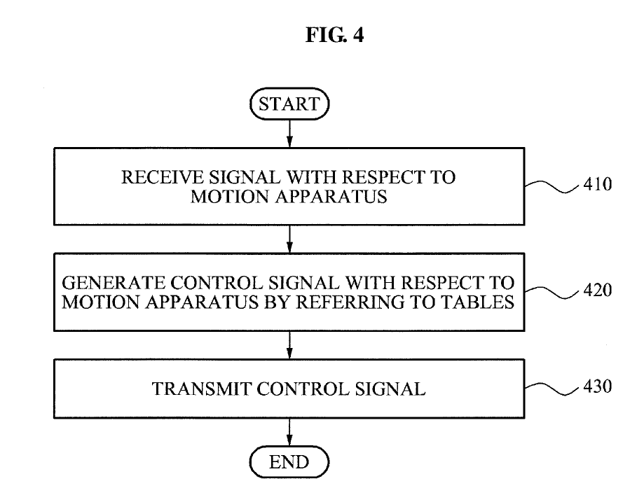

FIG. 4 illustrates a method of generating and reproducing a motion effect according to an embodiment of the present invention.

In operation 410, an apparatus for generating and reproducing the motion effect may receive a signal with respect to a motion apparatus providing a motion to a user. In operation 420, the apparatus for generating and reproducing the motion effect may generate a control signal with respect to the motion apparatus according to the signal with respect to the motion apparatus, based on tables where schemas indicating a conceptual motion effect with respect to the motion apparatus are stored. The apparatus for generating and reproducing the motion effect may transmit the control signal to the motion apparatus so that a variety of motion effects may be expressed with respect to a motion chair by means of the schemas indicating the motion effects.

To generate the control signal with respect to the motion apparatus, the apparatus for generating and reproducing the motion effect may combine at least two motion patterns defined in a basic motion table and a combinational motion table, so that the at least two motion patterns may have a single duration time and a single start point and then, may generate the control signal with respect to the motion apparatus using the combined at least two motion patterns in operation 420.

The basic motion table may include a move pattern indicating a rotation-free 3D motion based on the 6DoF with respect to the motion apparatus, and an incline pattern indicating a rotation including a pitch, a yaw, and a roll based on the 6DoF.

With respect to the motion apparatus, the combinational motion table may include at least one of a shake pattern indicating a repetitive motion into one direction and into an opposite direction of the one direction, a wave pattern indicating a successive up and down motion, a spin pattern indicating a continuous turning based on a single central point, a turn pattern indicating a motion in one direction, and a collide pattern indicating a motion occurring due to a collision between the motion apparatus and another object.

A pattern type of each of patterns in the tables where the schemas indicating the motion effect with respect to the motion apparatus are stored may refer to description of FIG. 2.

FIGS. 5A and 5B illustrate basic motion patterns stored in a basic motion table according to an embodiment of the present invention.

FIG. 5A illustrates a conceptual meaning of a move pattern, and FIG. 5B illustrates a conceptual meaning of an incline pattern.

FIGS. 6A through 6E illustrate combinational motion patterns stored in a combinational motion table according to an embodiment of the present invention.

FIG. 6A illustrates a meaning of a shake pattern. FIG. 6B illustrates a meaning of a wave pattern, FIG. 6C illustrates a meaning of a spin pattern, FIG. 6D illustrates a meaning of a turn pattern, and FIG. 6E illustrates a meaning of a collide pattern.

FIGS. 7A through 7I illustrate pattern types with respect to combined patterns according to an embodiment of the present invention.

FIG. 7A illustrates a meaning of a direction of a shake motion with respect to the motion apparatus in a shake pattern, FIG. 7B illustrates a meaning of a distance of the shake motion in the shake pattern, and FIG. 7C illustrates an interval of the shake motion in the shake pattern.

FIG. 7D illustrates a meaning of a direction of a wave motion with respect to the motion apparatus in a wave pattern, FIG. 7E illustrates a meaning of a start direction of the wave motion in the wave pattern, and FIG. 7F illustrates a distance between a top location and a bottom location moved through the wave motion. FIG. 7G illustrates a meaning of a turn angle in a turn pattern.

FIG. 7H illustrates a meaning of a horizontality-based direction receiving an impact in a collide pattern, and FIG. 7I illustrates a meaning of a verticality-based direction receiving the impact in the collide pattern.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for generating and reproducing a motion effect, comprising:
a receiving module to receive a signal with respect to a motion apparatus providing a motion to a user;
a generating module to generate a control signal with respect to the motion apparatus according to the signal with respect to the motion apparatus, based on tables where schemas indicating a conceptual motion effect with respect to the motion apparatus are stored; and
a transmitting module to transmit the control signal to the motion apparatus.

2. The apparatus of claim 1, further comprising:
a storage module to store the tables where the schemas indicating the conceptual motion effect are stored.

3. The apparatus of claim 1, wherein the tables where the schemas indicating the conceptual motion effect are stored comprises a basic motion table defining a basic motion pattern based on 6 degrees of freedom (DoF) with respect to the motion apparatus and a combinational motion table defining a combinational motion pattern with respect to the motion apparatus.

4. The apparatus of claim 3, wherein the generating module generates the control signal with respect to the motion apparatus by combining at least two motion patterns defined in the basic motion table and the combinational motion table, so that the at least two motion patterns have a single duration time and a single start point.

5. The apparatus of claim 3, wherein the basic motion table comprises a move pattern indicating a rotation-free three-dimensional (3D) motion based on the 6DoF with respect to the motion apparatus, and an incline pattern indicating a rotation comprising a pitch, a yaw, and a roll based on the 6DoF.

6. The apparatus of claim 3, wherein, with respect to the motion apparatus, the combinational motion table comprises at least one of a shake pattern indicating a repetitive motion into one direction and into an opposite direction of the one direction, a wave pattern indicating a successive up and down motion, a spin pattern indicating a continuous turning based on a single central point, a turn pattern indicating a motion in one direction, and a collide pattern indicating a motion occurring due to a collision between the motion apparatus and another object.

7. The apparatus of claim 5, wherein, with respect to the motion apparatus, the move pattern comprises at least one move pattern type among a movement distance in an X axis, a movement distance in an Y axis, a movement distance in a Z axis, a movement speed, and a movement acceleration.

8. The apparatus of claim 5, wherein, with respect to the motion apparatus, the incline pattern comprises at least one incline pattern type among an incline rotation in an X axis, an incline rotation in an Y axis, an incline rotation in a Z axis, a rotation speed and a rotation acceleration.

9. The apparatus of claim 6, wherein, with respect to the motion apparatus, the shake pattern comprises at least one shake pattern type among a direction of a shake motion, a counted number of shake motions during a duration time of the motion effect, a distance of the shake motion, and an interval of the shake motion.

10. The apparatus of claim 6, wherein, with respect to the motion apparatus, the wave pattern comprises at least one wave pattern type among a direction of a wave motion, a start direction of the wave motion, a counted number of wave motions during a duration time of the motion effect, a distance between a top location and a bottom location moved through the wave motion, and an interval of the wave motion.

11. The apparatus of claim 6, wherein the spin pattern comprises at least one spin pattern type among a spin direction to each of three axes, a counted number of spins during a duration time of the motion effect, and a spin interval.

12. The apparatus of claim 6, wherein the turn pattern comprises at least one turn pattern type among a turn angle and a turning speed.

13. The apparatus of claim 6, wherein the collide pattern comprises at least one collide pattern type among one horizontality-based direction receiving an impact due to the collision and one verticality-based direction.

14. A method of generating and reproducing a motion effect, comprising:
receiving a signal with respect to a motion apparatus providing a motion to a user;
generating a control signal with respect to the motion apparatus according to the signal with respect to the motion apparatus, based on tables where schemas indicating a conceptual motion effect with respect to the motion apparatus are stored; and
transmitting the control signal to the motion apparatus.

15. The method of claim 14, wherein the tables where the schemas indicating the conceptual motion effect are stored comprises a basic motion table defining a basic motion pattern based on a 6 DoF with respect to the motion apparatus and a combinational motion table defining a combinational motion pattern with respect to the motion apparatus.

16. The method of claim 15, wherein the generating comprises:
generating the control signal with respect to the motion apparatus by combining at least two motion patterns defined in the basic motion table and the combinational motion table, so that the at least two motion patterns have a single duration time and a single start point; and
generating the control signal with respect to the motion apparatus using the combined to at least two motion patterns.

17. The method of claim 15, wherein the basic motion table comprises a move pattern indicating a rotation-free 3D motion based on the 6DoF with respect to the motion apparatus, and an incline pattern indicating the spin comprising a pitch, a yaw, and a roll based on the 6DoF.

18. The method of claim 15, wherein, with respect to the motion apparatus, the combinational motion table comprises at least one of a shake pattern indicating a repetitive motion into one direction and into an opposite direction of the one direction, a wave pattern indicating a successive up and down motion, a spin pattern indicating a continuous turning based on a single central point, a turn pattern indicating a motion in one direction, and a collide pattern indicating a motion occurring due to a collision between the motion apparatus and another object.

19. The method of claim 17, wherein, with respect to the motion apparatus, the incline pattern comprises at least one incline pattern type among an incline rotation in an X axis, an incline rotation in an Y axis, an incline rotation in a Z axis, a rotation speed and a rotation acceleration.

20. The method of claim 18, wherein, with respect to the motion apparatus, the wave pattern comprises at least one wave pattern type among a direction of a wave motion, a start direction of the wave motion, a counted number of wave motions during a duration time of the motion effect, a distance between a top location and a bottom location moved through the wave motion, and an interval of the wave motion.
